(19) United States
(12) Patent Application Publication
(10) Pub. No.: US 2021/0329345 A1
(43) Pub. Date: Oct. 21, 2021

(54) ACQUISITION OF GOODS FROM VIDEO CONTENT

(71) Applicant: SHIFT Commerce LTD, Leeds (GB)

(72) Inventor: Shane William Quigley, Leeds (GB)

(21) Appl. No.: 17/232,474

(22) Filed: Apr. 16, 2021

Related U.S. Application Data
(60) Provisional application No. 63/010,882, filed on Apr. 16, 2020.

(51) Int. Cl. H04N 21/478; H04N 21/658; G06Q 30/06; H04N 21/8545; G06F 16/78; G06F 16/783

(52) U.S. Cl. CPC H04N 21/47815; H04N 21/6581; G06Q 30/0603; G06Q 30/0613; G06F 16/7867; G06F 16/783; H04N 21/8545

(57) ABSTRACT

This disclosure relates to systems and methods for creating interactive video content from existing video data and providing the interactive video content to users on consumer devices concurrent with the existing video data being displayed on a broadcasting device.

### CROSS-REFERENCE TO RELATED APPLICATIONS

This application claims the benefit of, and priority to, U.S. Provisional Patent Application No. 63/010,882, filed Apr. 16, 2020, the contents of which are incorporated by reference.

### TECHNICAL FIELD

This disclosure relates to systems and methods of purchasing goods from video content.

### BACKGROUND

Internet and remote shopping are rapidly replacing traditional shopping formats. Roughly 20.3 percent of all retail transactions are now online. Unfortunately, current platforms for online shopping lack essential capabilities needed for retailers to keep pace with changing market trends.

### SUMMARY

The prevalence of online shopping makes video a crucial source of marketing and communication, yet technologies for shopping from video remain poorly recognized. Moreover, when you consider the substantial amount of existing video content that is available, it is clear the need for video platforms that engage with customers is shackling consumer marketplaces from reaching their potential. And without the ability to engage with consumers, retailers are unable to keep pace with changing market trends.

This disclosure provides systems and methods useful for retailers to keep pace with changing market trends while enhancing consumer marketplaces. In particular, this disclosure provides systems and methods for transforming existing, non-interactive video content from broadcast devices (e.g., home televisions or in-store displays) into an interactive and shoppable video format for engagement by consumers on personal devices (e.g., a smartphone or tablet). The broadcast devices can display the existing video content concurrently with interactive video content that is supplied to consumer devices upon request. Concurrent transmission of non-interactive video on a broadcast device and interactive video content on a consumer device provides numerous commercial and marketing advantages not currently available. For example, it provides consumers with a platform to engage directly with products or retailers as those products are made available through video broadcasts. It also provides a convenient mechanism for consumers to uncover detailed information about products and/or make purchases without the burden of independent research. Moreover, because interactive video content is provided to consumer devices, upon request, coincident with non-interactive video broadcast, it provides consumers the freedom to decide when to engage with interactive video content while providing a reminder (vis-à-vis a broadcast display) that interactive video content is readily available. As such, systems and methods of the invention provide unique opportunities for tracking consumer engagement with products and assessing marketing strategies. For example, systems and methods of the invention can provide real-time feedback of consumer interest in products. For example, data of consumers that view video content on broadcast devices (e.g., in-store displays) without engaging with its content (e.g., requesting an interactive version on a consumer device) may be collected concurrently with data on consumers that do engage since the broadcasted video and interactive video are displayed separately and concurrently. These data may be useful for retailers to gain a better understanding of consumer preferences and tailor retail strategies around those preferences.

Systems and methods of the invention are useful for creating interactive video content from existing video data, such as video advertisements. Generally, video advertisements are non-interactive. As such, consumers have little to no control over the type of information that is presented. If pertinent product information is not provided in the video advertisement, it is not communicated to the consumer. If too much information is provided in the video advertisement, the consumer is overwhelmed and unable to process the information. Thus, retailers are forced to choose between providing too much information and too little information. Moreover, information that is important to one consumer is often not important to another consumer. As such, creating a non-interactive video with a perfect balance of information to inform consumers of products or services is difficult.

Methods and systems of the invention address this limitation by creating interactive video content that allows a consumer to engage with existing video, e.g., the video advertisements, and decide when and what information is displayed. Because interactive videos are created from existing video content, methods and systems of the invention can be rapidly and inexpensively incorporated into existing commercial and/or marketing pipelines by obviating the need to create new digital content from scratch.

In one aspect, this disclosure provides a method useful for digital commerce. The method generally involves providing a computer system having, among other things, at least one processor coupled to non-transitory, computer-readable memory containing instructions executable by the at least one processor to cause the system to communicate data with a plurality of devices over a network. The network may be a wireless network to allow any number of devices across any distance to coordinate and facilitate commercial transactions.

The computer system may receive a video (e.g., a broadcast video) via the wireless network. The video typically is a video advertisement marketing products or services useful to a consumer. The video can include a plurality of images arranged to display moving visual media showing products or services of that are of interest. The method involves analyzing the plurality of images to identify one or more products based, at least in part, on image information from a database, such as, a product catalog database. Information from the catalogue database may include product images and relevant product information obtained by web-implemented computer software from retailer websites. Analyzing can involve image recognition using computer algorithms such as those involved in machine learning systems.

Methods of the invention further involve indexing the plurality of images with metadata, e.g., from the product catalogue database, that is associated with the one or more products to create indexed images. The indexed images link metadata (e.g., product images, information, hyperlinks to retailer webpages) to the images of the video. The indexed images are used to generate interactive video content. The interactive video can provide all the digital information of the original images in an enhanced format that provides useful information which can be interacted with by consumers. Methods further include receiving, via the network, a request from a consumer device for the interactive video concurrently with the video being displayed on a broadcasting device and communicating the indexed video to the consumer device.

Advantageously, receiving and/or providing interactive video content concurrently with display of non-interactive video gives consumers the freedom to choose when and how to engage with interactive content while maximizing the number of consumers that may enjoy the video broadcast. For example, in some embodiments the broadcasting device is a video display device (such as a flat-screen television or video monitor) located in a public location such as in a retail store where consumers visit and shop for goods and/or services. A consumer, intrigued by a product from the video broadcast, can individually request an interactive copy of the video to further explore and/or purchase the product without disruption to other consumers. Any number of other consumers may engage concurrently with one another. As such, methods of the invention are further useful to maximize the number of consumers that receive video content.

In some embodiments, the interactive video content and the non-interactive video are displayed substantially in sync with each other by the broadcasting device and the consumer device, respectively. As one or more products appear in the videos, at least a portion of the metadata related to the one or more products may be provided to the consumer device. The metadata can be displayed in response to a consumer's interaction with the indexed video, e.g., by clicking on an item being displayed. Interacting with the interactive video can cause metadata to be displayed. The metadata includes information relating to both products and services. For example, the metadata may include information relating to price, availability, location, or product specifications.

In some embodiments, methods of the invention further include receiving, from the consumer device, a purchase request for the product. The purchase request may be initiated by the consumer device by interacting with the video. In some embodiments, after receiving the purchase request, systems and methods of the invention transmit information related to the purchase request to a third-party device (e.g., a computer or server) to facilitate a commercial transaction or track analytical data. Accordingly, systems and methods of the invention are useful for connecting a plurality of individual retailers to consumers on a single unified system.

In some embodiments, methods of the invention may involve recording and transmitting, with the computer system, analytical data related to, for example, a number of views and or purchases of products identified in the interactive video. The data can include information showing of a population of consumers in a vicinity of a broadcast device, hosting a non-interactive video advertisement, how many consumers or what percentage of those consumers requested an interactive version of the video for engagement. The data may further show, among those consumers, how far into the video did the consumers watch, and how many times was the interactive video repeated. Advantageously, these methods improve existing informational technologies used to assess markets by providing real time market feedback of consumer interests based on consumer engagement with interactive data. Such methods are further useful to identify target demographics based on areas or locations where consumers show an interest in certain products or services which is useful to tailor market strategies.

Systems and methods of the invention may use any number of personal and/or computer-implemented approaches to create interactive video content. For example, in some embodiments, information used to create interactive videos, provided by a product catalogue database, includes information provided manually by a retailer. For example, a retailer may input data into a computer system to identify and/or describe goods or servers in a video broadcast. As discussed in more detail below, the video broadcast does not need to be created by the retailer. In other instances, the information is automatically, for example, with a computer algorithm associated with the computer system, scraped from a website associated with the retailer to provide a more convenient method of generating interactive data.

In some embodiments of the method, the request received from the consumer device includes a unique identifier identifying the requested indexed video. The unique identifier may include one of a URI matching a URI associated with the video content, a URI matching a URI associated with a location of the broadcasting device, or global positioning coordinates of the consumer device.

In another aspect, the invention relates to a system useful for facilitating the purchase of goods from video content. The system may include at least one processor coupled to non-transitory, computer-readable memory containing instructions executable by the at least one processor to cause the system to receive a video comprising a plurality of images presenting one or more products; analyze the plurality of images to identify the one or more products based, at least in part, on information from a product catalogue database; index the plurality of images with metadata associated with the one or more products to create an indexed images; with the indexed images, created an interactive video; receive, from a consumer device, a request for the interactive video concurrent with the video broadcast being displayed on a broadcasting device; and provide the interactive video to the consumer device. In some embodiments, the system is further operable to receive a purchase request from a consumer device and provide information related to the purchase request to a third-party computer device.

### BRIEF DESCRIPTION OF THE DRAWINGS

FIG. 1 diagrams an exemplary method of the invention.

FIG. 2 is a block diagram of an exemplary computer system.

FIG. 3 shows a flowchart diagram for automated product recognition by machine learning.

FIG. 4 illustrates a request for interactive video content with a consumer device.

FIG. 5 is a block diagram identifying relationships among various modules of the invention.

FIG. 6 shows video displayed on both a consumer device and a broadcasting device.

FIG. 7 shows video display of a consumer device and a broadcasting device.

FIG. 8 shows an exemplary broadcast device.

FIG. 9 shows an exemplary broadcast device inside a store.

FIG. 10 shows an exemplary broadcast device in a store window.

FIG. 11 shows an exemplary broadcast device at a transport hub.

FIG. 12 shows exemplary data collected by systems and methods of the invention.

### DESCRIPTION

The present disclosure provides an approach for creating and transmitting interactive video from a non-interactive video display to a consumer device. The non-interactive video includes video that is broadcast on a display (e.g., a television) in an environment. The environment may be a public environment or a private environment. For example, non-interactive video may be broadcast on a television of a department store. The video can include images of one or more products or services that are of interest to a consumer. The consumer, by executing on systems and methods provided by this disclosure, is provided with an interactive copy of the video on a consumer device (e.g., a smartphone). The consumer can engage with the interactive video on the consumer device to, among other things, receive information about products or services displayed in the video, make purchases, or communicate with a seller. The consumer can engage with interactive video content concurrently with the of the non-interactive video broadcast.

To accomplish this convenient, and ideally instantaneous or at least apparently instantaneous to any one or more of the consumers, transition between providing consumers non-interactive video and providing interactive video content, the present disclosure provides a system comprising an interoperable mesh of technologies and devices that coordinate across data networks to connect consumers with retailers.

For purposes of discussion, and ease of explanation, exemplary systems and methods described herein refer to providing products and services generally. However, it should be understood that systems and methods of the present invention apply to all types of products, goods, services, resources, and the like, and are not limited solely by any one product or type thereof. Products may be tangible or intangible. Tangible products may include convenience products, such as, coffee, tea, sugar, newspapers, groceries, food, beverages. Tangible products may also include shopping products, such as, computers, furniture, clothing, shoes, jewelry. Tangible products may include sporting goods, such as, surf boards, skis, bicycles, gym equipment. Intangible products may include digital goods, such as, JPG and/or MP3 files.

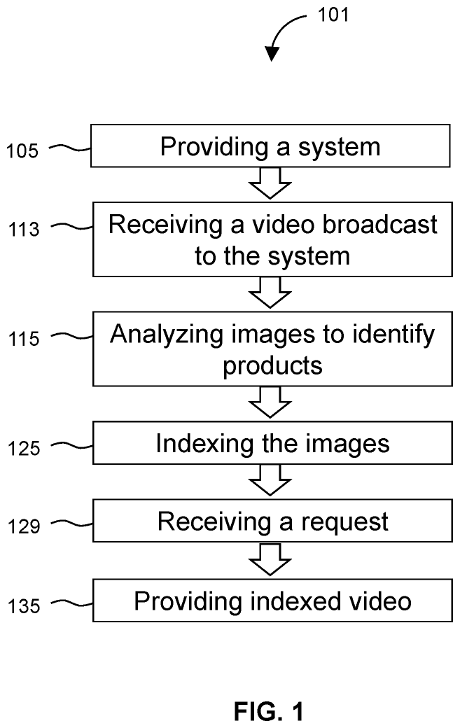

FIG. 1 diagrams an exemplary method 101 of the invention. Specifically, illustrated is a simple flow diagram to provide a general overview of methods of the invention according to some embodiments. The method 101 involves providing a computer system 105 comprising at least one processor coupled to non-transitory, computer-readable memory containing instructions executable by the at least one processor to cause the system to communicate and exchange data with a plurality of devices over a network.

The method further includes receiving 113 a video. The video includes digital content, i.e., electronic representation of moving visual images (video) in the form of encoded digital data, that is, or is intended to be, transmitted to one or more persons electronically. For example, the video may comprise a video broadcast of products and/or services offered by one or more retailers. The video may be a video advertisement. The video may be received 113 before, during, or after, the video is displayed on a broadcasting device. The video typically is received before it is broadcast on the broadcasting device.

In some embodiments, the video is received via a data transmission over the Internet. The Internet includes involves a global system of interconnected computer networks that use Internet protocol suite (TCP/IP) to communicate and exchange data between networks and devices. The video may be transmitted to and or from the system in any format, for example, the format may be MPEG-4 AVC, AVCHD, FLV, or MP4. For example, without limiting the scope to any one format, the video can be transmitted in MPEG-4AVC. Transmission of video content in MPEG-4AVC comprises a cosine transform (DCT) algorithm with a high compression ratio making MPEG-4AVC format ideal for rapid transmission of video content that is particularly well suited in embodiments that involve live streaming.

In some embodiments, the video may be transmitted using a File Transfer Protocol (FTP) through any one of a variety of FTP software programs available on the Internet. For example, an operator of a system of the invention may specify an FTP address, a username and a password that a producer (e.g., retailor) of a video with one or more product images will use to connect to the FTP server and an HTTP(S) prefix of the URL at which the file will be available upon upload. The producer of the video may then enter the address of the FTP server and upload the video to the corresponding host field.

The video may be uploaded to a video storage database using server software operably associated with the system. The video storage database may be hosted on a server. The video may subsequently be copied into a video database. The video database provides for an organized collection of video data that may be stored, archived, and accessed electronically via one or more server components or modules of the computer system. In some embodiments, the video is processed by a video compression application that compresses the video into multiple qualities and sizes to provide consumer devices an optimal video stream, e.g., without stopping to buffer, by, for example, adapting to internet connectivity and capabilities of consumer devices. Video compression may involve a bit-rate reduction process that encodes video information using fewer bits than provided by the original broadcast video. It generally is best if the video compression does not substantially impact viewable qualities of the plurality of images. For example, video data may be transmitted and compressed as described in U.S. Pat. No. 9,774,848B2, which is incorporated herein by reference.

The method 101 further involves analyzing 115 the plurality of images to identify, index, and/or tag products from the images with information relevant to consumers. Analyzing 115 the plurality of images may be performed with an image analysis service, for example, a service hosting a machine learning algorithm.

In some instances, analyzing 115 images of the video involves an image analysis and/or image recognition computer software. In some instances, the video is digitally segmented into distinct images, wherein each image may be assigned a unique barcode or unique identifier to quickly archive, retrieve, and reassemble the images back into original video format. Preferably, the unique barcode or identifier comprises information, such as a time stamp, that associates the image with when the image appears in the video during the progression of the video. The images may be individually analyzed to extract information. Information extracted from the images may be analyzed by matching information extracted from the images against information extracted from images of confirmed products or services. Digital correlations of information identified beyond a pre-determined threshold may indicate that the confirmed product is displayed in the image data. Image analysis can be performed by an Image Analysis Service via machine learning algorithms.

Products identified in the images are tagged or indexed with information and images from a product catalogue database. The product catalogue database may be populated by a retailer manually by, for example, uploading a spreadsheet file into a management admin panel of the computer system.

In some embodiments, the product catalogue database is populated automatically populated with a web crawler. A web crawler is an Internet device that systematically browses webpages of the Internet often for the purpose of Web indexing (web spidering). According to some aspects of the invention, the web crawler may be used to visit a list of URLs associated with one or more retailers, e.g., a retailer's home webpage. As the crawler visits these URLs, it may browse and identify all hyperlinks in the webpages and add those hyperlinks to a list of URLs to visit, called the crawl frontier. The URLs from the frontier may be recursively visited according to a set of pre-determined criteria. The crawler(s) can visit and archive products, product information, and images of the products offered by retailer webpages. As information of the products are imported, images of the products are downloaded and stored in an image database. Images of the image database may be used by image analysis software to identify products and associated time stamp information form the video. The information can be archived in such a way that is readily viewed, read, and associated with images from the video.

After analyzing 115 images extracted from a video to identify one or more products, the method 101 involves indexing 125 (e.g., tagging) the images with metadata. Indexing, as referred herein, involves linking images from the video with product images and/or information related to the products (e.g., price, availability, etc.). For example, in instances where an image of a product is found to correlate with any portion of an image of a video, that image from the video may be indexed or tagged with metadata. The image may be indexed or tagged by associating the unique identification information of the image with metadata of a corresponding product, thereby linking metadata of the product with the image. Based on the linked product images, a consumer will be able to manipulate a video, obtain new information about products that appear in the video, or shop the products without performing any additional steps, such as stopping the video to search for products that appear interesting in the video.

The metadata may include product images and information from the product catalogue database, e.g., that is associated with the one or more products. The metadata may further include hyperlinks directing consumers to one or more webpages associated with a retailer or vendor of the product. A hyperlink may, for example, direct a consumer to a webpage where the product may be purchased. The indexed images may be collated based on time stamp information to generate an interactive video.

Preferably, the interactive video comprises a collection of indexed images that provides (e.g., shows, displays, illustrates, presents, discusses, etc.) one or more products or services identified in the original video to a consumer on a consumer's device. The interactive video may include representations (e.g., snapshots, photographs, drawings, models, 3D representations, or any other representation) of the products or services. The product representations/images displayed in the interactive video may be selectable (e.g., by the consumer). The ability to select a particular product may allow a consumer to request that the interactive video display additional metadata, e.g., a hyperlink to a webpage for purchasing the product.

After generating an interactive video, the method includes receiving 129, typically over a network, a request from a consumer device for the interactive or indexed video. The request may be received concurrently with the video broadcast being displayed on a broadcasting device. The request for the interactive video can be received from the consumer device during or after the video broadcast is displayed on the broadcasting device. In response to the request, the method includes providing 135 the interactive video to the consumer device. The interactive video may be provided to the consumer device over a data network by a video over Internet protocol.

Unique Resource Identifiers (URIs) can be used to associate non-interactive video content with interactive video content created by systems of the invention. URIs provide a means of locating and retrieving videos on one or more networks (e.g., the Internet or on another private network, such as a computer filesystem or an Intranet), which are referred to as Uniform Resource Locators (URLs). The URI may be generated after creating an indexed video. The URI may be generated and stored in the video database of the system. URIs typically involve web browsers. Once the URI is published (e.g., displayed on a broadcast device) interactive, indexed videos may be accessed publicly via their URI. For example, a consumer may enter a URI displayed on a video of the broadcast video into a web browser of a consumer device to request interactive video content on the consumer device. As a person of skill in the art will readily recognize, the URI can also be a QR code, which is a type of barcode that is made machine-readable via an optical label and that contains information about the item to which it is attached.

In some instances, it may be useful for video displayed on broadcast devices to be synchronized with video content on consumer devices. To synchronize video content with consumer devices, broadcast displays may be configured against the video of a video database of the system. This may allow current playback time of individual broadcast devices, such as, in-store screens or digital advertising boards in travel hubs or at live sporting events, to be broadcast back to the video database of the system. Each of these locations may have its own URI and may also have longitude and latitude coordinates and geofencing coordinates for the purpose of the consumer devices being able to automatically locate the corresponding interactive video.

When a URI is accessed, it can be routed through a content delivery network of the system to provide high video quality. Routing the URI through the content delivery network is configured to ensure consistent performance even under events having high data traffic, which may be caused by television advertising. The delivery network may store temporary copies of video on the network for quick access, via a caching process. In some instances, a cache cannot serve a request, the system may call a web app server to facilitate the request.

According to various embodiments of the invention, interactive video content may be recalled through multiple approaches. For example, a consumer, may input into a web browser of a consumer device a URI. Where the URI matches a URI of a video, the video may be provided to the consumer device. In other embodiments, the URI entered may be matched against a URI associated with a physical location. For example, a stadium or any other venue may have associated URIs that, when entered into consumer devices, deliver to those consumer devices video displayed on broadcasting devices of the venue. In other instances, a location of the consumer's device reported by, e.g., a global positioning device of a smart phone, may be used to deliver interactive video corresponding to a nearby (e.g., within a geofence) of a video broadcast displayed on a broadcasting device.

In some instances, if the requested video broadcast is transmitting a playback time of the video on display, the interactive video presented to the viewer may initiate from the same temporal position. Otherwise, the video will initiate from a different point in the video, such as the beginning.

In some embodiments, before an interactive video is played, the current strength of internet connectivity and/or capability of a consumer device may be analyzed. For example, a video processing power and/or screen resolution may be assessed so as to select appropriate video stream quality levels. If attributes change during playback, the video may automatically switch to another resolution to ensure the video stays in-sync without requirement of buffering.

Video content can be served to consumer devices via a caching server, such as, for example, a content delivery network. Once a video loads and plays on a screen of a consumer device, identified products from a catalogue database of the system may appear concurrently with products appearing in the video. For example, the products may appear in synch with the product appearing in the video. In some instances, product imagery is routed via an image transformation service to dynamically serve image size and format data based on capabilities of the consumer's device. Videos and product imagery can be cached in a geographically local server, such as, a content delivery network.

According to some aspects, this disclosure provides a system having at least one processor coupled to non-transitory, computer-readable memory containing instructions executable by the at least one processor to cause the system to receive a video broadcast comprising a plurality of images presenting one or more products analyze the plurality of images to identify the one or more products based, at least in part, on information from a product catalogue database; index the plurality of images with metadata associated with the one or more products to create an interactive video from the indexed images; receive, from a consumer device, a request for the interactive video concurrent with the video broadcast being displayed on a broadcasting device; and provide the indexed video to the consumer device. The system is further operable to receive a purchase request from the consumer device and provide information related to the purchase request to a third-party computer device.

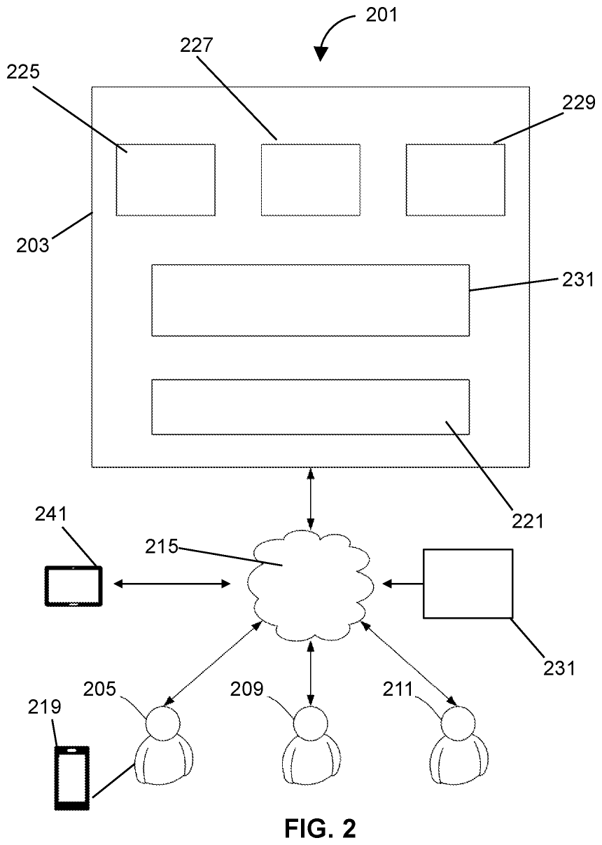

FIG. 2 is a block diagram of an exemplary computer system 201. The system may include a server 203 embodied on an internet-based computing system/service. For example, the server 203 may be embodied on a cloud-based service, for example. The server 203 may be configured to communicate and share data with one or more consumers 205, one or more vendors 209, and/or one or more retailers 211 over a network 215. In the present context, the consumers 205 may include any person or group who purchases goods and services for personal use. A vendor may include any person or entity that is a supplier of goods or services. A retailer may be any person or business that sells goods to the public in relatively small quantities for use or consumption rather than for resale.

The system 201 may further include an external computing system/server (not shown) operable to communicate with at least one cloud-based service, and subsequently the server, via the network 215. The external computing system/server may be embodied as a remote server, for example, for communicating with the server and for performing the other functions described herein. Similarly, in some embodiments, the server 201 may be embodied on the external computing system/server. In the embodiments described herein, the external computing system/server may be embodied as a remote server having one or more databases associated with the server, as will be described in greater detail herein.

The network 215 may be any network that carries data. Non-limiting examples of suitable networks that may be used as network include Wi-Fi wireless data communication technology, the internet, private networks, virtual private networks (VPN), public switch telephone networks (PSTN), integrated services digital networks (ISDN), digital subscriber link networks (DSL), various second generation (2G), third generation (3G), fourth generation (4G) cellular-based data communication technologies, fifth generation (5G) communication technologies, Bluetooth radio, Near Field Communication (NFC), the most recently published versions of IEEE 802.11 transmission protocol standards as of June 2015, other networks capable of carrying data, and combinations thereof. In some embodiments, network is chosen from the internet, at least one wireless network, at least one cellular telephone network, and combinations thereof. As such, the network may include any number of additional devices, such as additional computers, routers, and switches, to facilitate communications. In some embodiments, the network may be or include a single network, and in other embodiments the network may be or include a collection of networks.

The server 201 is configured to provide an interface with which one or more consumers, vendors, and/or retailers may interact (directly or indirectly) for the purposes of providing interactive video content of products that is enhanced with product information. The server is further configured to provide an interface with which a seller, for example, may interact for the purposes of identifying and indexing products from non-interactive video data. The server is further configured to provide an interface with which the consumer can display and interact with the interactive video.

For example, the server 201 may be operable to communicate and share data with a device 219 associated with one or more consumers (i.e., a consumer device). The consumer device 219 may be embodied as any type of device for communicating with the server and cloud-based service, and/or other user devices over the network. For example, at least one of the consumer devices may be embodied as, without limitation, a computer, a desktop computer, a personal computer (PC), a tablet computer, a laptop computer, a notebook computer, a mobile computing device, a smart phone, a cellular telephone, a handset, a messaging device, a work station, a distributed computing system, a multiprocessor system, a processor-based system, and/or any other computing device configured to store and access data, and/or to execute software and related applications consistent with the present disclosure.

The consumer device may include an interactive display device operable to display and engage with interactive video data. The display surface may be configured to simultaneously display a visual output of an interactive video and a product or information on a product that is of interest. The interactive display device may include one or more components configured to detect consumer interactions, e.g., a touch screen. The exchange and handling of data between the server 215 and as well as the various databases is generally managed by the distributed database management module 221.

The distributed database management module 221 may generally operate according to a distributed data model, in which storage devices (e.g., databases 225, 227, 229) are not all attached to a common processing unit. For example, one or more of the databases 225, 227, 229 may be stored different computers or servers, located in the same physical location or may be dispersed over a network of interconnected computers. For example, some of the databases may be distributed across multiple physical locations, such that they can reside on network servers on the Internet, on corporate intranets or extranets, or on other networks. Accordingly, by storing data across multiple computers, distributed databases can improve performance at end-user worksites by allowing transactions to be processed on many machines, instead of being limited to one. The distributed database management module 221 is configured to manage the exchange of data between consumers 205 and a video broadcast source 231 and the server 201 so as to convert non-interactive video into an interactive video that is provided to the consumer on the consumer device 219.

The product catalogue database 225 may generally be used for the storage of profiles associated with products, wherein each profile includes information related to an identity of a product or unit of product, characteristics of the product or unit of product, location of the product or unit of product, characteristics of the location. The characteristics of the product or unit of product may include, for example, physical attributes of the product or unit of product, origin of the product or unit of product, destination of the product or unit of product, and a combination thereof. Similarly, the characteristics of the location of the product or unit of product may include the operator of the location, overall capacity of the location, current capacity of the location, seasonality of the location, operational status of the location, current weather at the location, and a combination thereof. The product catalogue database 225 may further include traceability information related to the product (e.g., origin, destinations, etc.)

The server 203 of the present invention is configured to receive input from vendors and retailers for the assignment of a reference to a unique identifier associated with a product at the point of sale or delivery of such product. For example, one form of an input may be received from a retailer or seller who wishes to provide product price information, as well as other types of information, for inclusion in metadata attached to interactive video content. The information is presented to the consumer 205 who purchased or is interested in purchasing the product by interacting with the consumer device 219.

For example, as an initial step, a consumer making a request for interactive content of a video broadcast may be required to provide data that identifies the interactive video requested.

Accordingly, methods of the invention may involve creating a unique identification code, e.g., a URI, and associating the code with the non-interactive video. For example, the URI may be stamped on images of the video such that as the video is displayed on a broadcast device 241, the unique identification code is observable to consumers. Accordingly, systems and methods of the invention may be operable to receive existing, non-interactive video, process the video, and transmit the video directly to the broadcasting device 241, or alternatively, to the original data source 231.

Accordingly, the server may include a database that stores a plurality of different and separate product URIs associated with a plurality of different and separate videos. The plurality of different and separate URIs may relate to videos associated with different locations. The URIs may be stored in a video database, for example. In some embodiments, some of the product information identified in a video may include a URI associated with its corresponding video. Additionally, or alternatively, the plurality of different and separate URIs may be used to label other informational data to associate the data with corresponding video sources.

In other aspects, this disclosure can provide a method useful for training machine learning systems to identify products from video broadcast data. In some embodiments, for example, systems of the invention train machine learning systems to identify products from video (e.g., video broadcasts) with training data scraped directly from vendor websites, distributor websites, and/or social media. Systems of the invention may scrape retailer and/or vendor websites for verified product images. Systems of the invention can supplement image data from retailers by scraping social media platforms for images of products for which the identity (e.g., make, model, vendor, etc.) of the product is provided by the media (e.g., in a media post or comments).

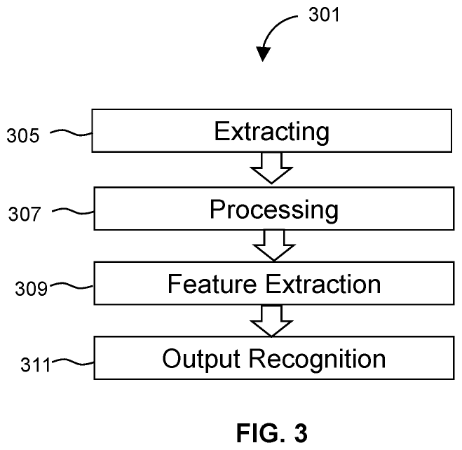

FIG. 3 shows a flowchart diagram for automated product recognition by machine learning. The method generally involves the steps of extracting 305 images from video broadcast data; processing 307 the imagines; feature extraction 309 from the images (i.e., identifying products); and output recognition 311. Methods can use images of products, for example, from a product catalog database, to train the machine learning system to identify products in the images. Methods of training can include supervised or unsupervised approaches.

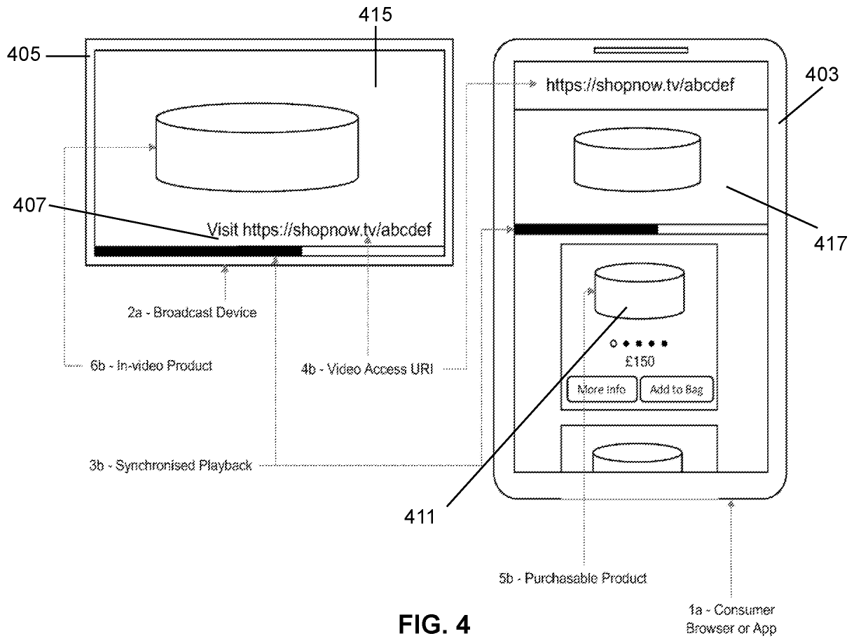

FIG. 4 illustrates a request for interactive video content with a consumer device 403. According to some embodiments, after non-interactive video content is received, a unique resource identifier (URI) is generated and associated with the video 407. The video may be stored in a video database. The video may be transmitted to a broadcasting device 405 for display. The video may be transmitted instantly or may be scheduled for display at a later time point. Once the video is displayed, an interactive version of the video can be accessed publicly via the URI 407. For example, a consumer may input the URI 407 into a web browser hosted by the consumer device 403, or the consumer may input the URI 407 into a software application that is associated with the system. Upon entering the URI 407, an interactive copy of the video that is displayed on the broadcasting device is retrieved and transmitted to the consumer device 403. The interactive video includes images of products 411 that appear in the broadcast video 415. The product images 411 may be presented below the interactive video 417.

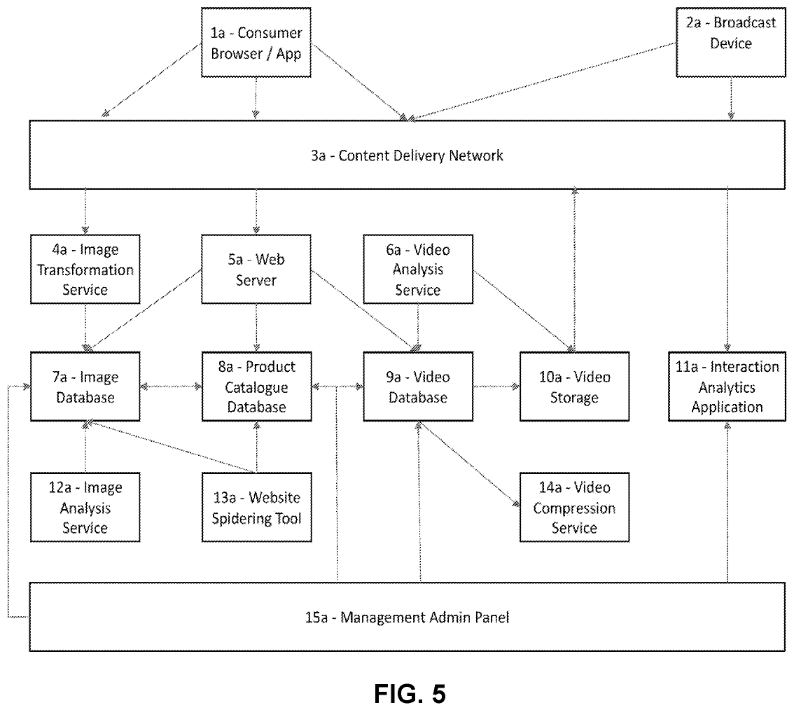

FIG. 5 is a block diagram identifying relationships among various modules of an exemplary system. The system includes a content delivery network, which can hosted on a server, useful for communicating video data between broadcast devices and consumer devices. The content delivery network can have an interface for interacting with consumers and/or retailers. The content delivery network can receive non-interactive video content from a video provider such as a retailer and/or a broadcast device and transmit the video to one or more of an image transformation service, a web server, a video storage, or an interaction analytics application. The video can be stored in a video database and/or processed by a video compression service. The video may be transformed into an interactive video by analyzing individual images of the non-interactive video for products and subsequently indexing those images with metadata associated with the products that are identified. The products may be identified using a computer algorithm such as a machine learning algorithm trained to identify correlations between the video images and product images stored in an image database. The products can be identified by human input, such as, the retailer. The images may be provided to the image database by a website spidering tool. After identifying products in the images, the images are indexed with product and image information from a product catalog database to create an interactive video. The interactive video can be provided to consumer devices via the content delivery network. A management admin panel associated with the system may be used to control various operations of the system, such as, what images are stored in the image database.

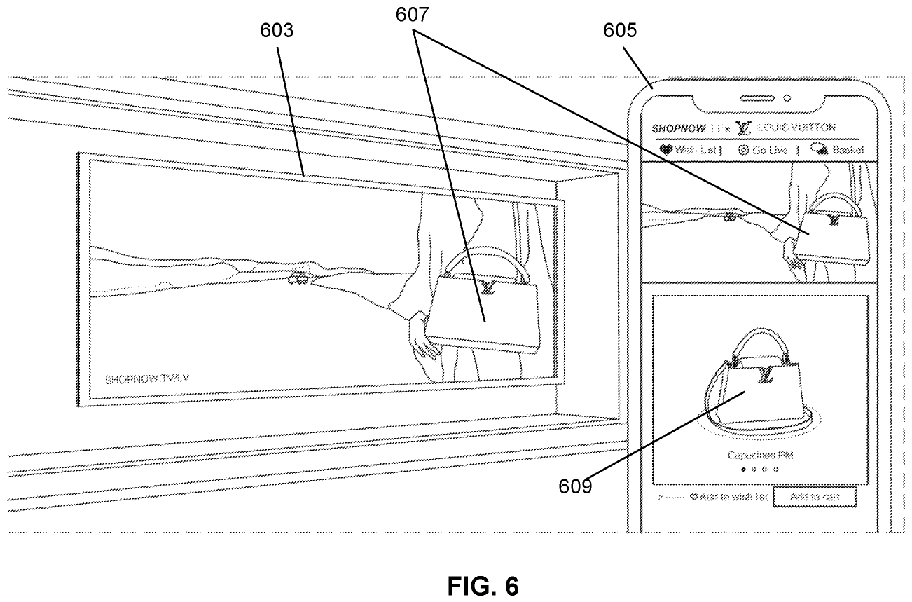

FIG. 6 shows a video displayed on both a consumer device 605 and a broadcasting device 603. The video displayed on the broadcasting device 603 is a non-interactive video. The video displayed on the consumer device is an interactive video produced by systems and methods described herein. The video displays typically are synchronized. As images of products 607 appear in the videos, the products 607 displayed on the consumer device 605 appear with product images 609 and information relevant to the product. The product images 609 and information can be provided from a product catalog database. The interactive video is provided in a shoppable format. By interacting with the consumer device 605, e.g., double tapping the product image 609, the consumer can display additional information about the product 607 and/or purchase the product 607. The product image 609 can appear on the consumer device automatically, or, after the consumer engages with the interactive video by, for example, tapping the product 607 displayed.

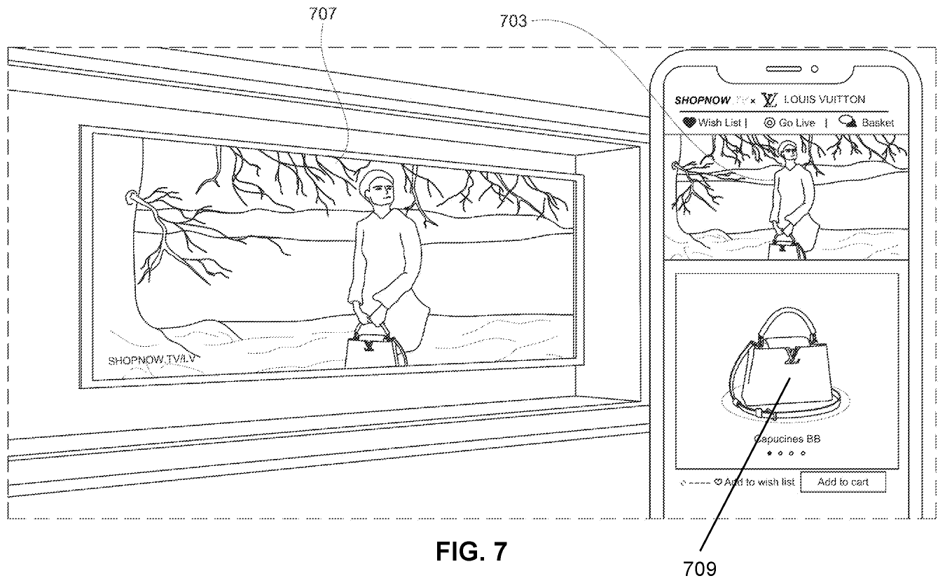

FIG. 7 shows video display of a consumer device 703 and a broadcasting device 707. As video content changes during the progression of the video, products available for consumer interaction on the consumer device 703 update accordingly. The products available for interaction are represented in the interactive video by product images 709. The product images can be interacted with, e.g., by tapping on the product image. Interacting with the product image can provide additional about the product or provide the consumer with an opportunity to purchase the product. In some instances, consumers can adjust the progression of the video on the consumer device 703. For example, consumers can rewind, fast-forward, or restart the interactive video. Consumers can also adjust the video to play in synch with the broadcasting device 707.

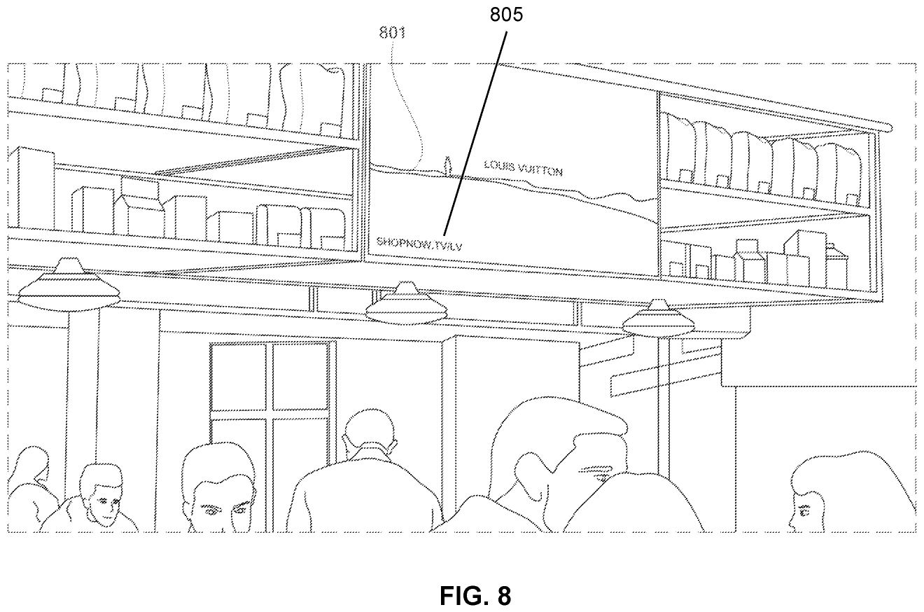

FIG. 8 shows an exemplary broadcast device 801. The broadcast device 801 is located at a public café. Displayed on the broadcast device is a non-interactive video advertisement of one or more products. Consumers interested in the products can use their own personal devices to request and receive interactive video content of the video advertisement. The interactive video content will include additional information on the products displayed on the broadcast device. To request the video, consumers can input unique video identification information 805 presented in a conspicuous location of broadcast video into a web browser or application on the consumer's personal device. The information can be a web address. Inputting the information 805 into the personal device can direct, for example, a web browser of the device to a content delivery network. The content delivery network can comprise a server which is operable to provide the interactive vide to the consumer upon request. The request can be made by providing input into an interact associated with the content delivery network. The request can be an automatic based on the consumers input of the information 805 into the web browser. In response, the content delivery network is operable to provide the interactive video. The interactive video can be displayed on the consumers device via a video player associated with the content delivery network.

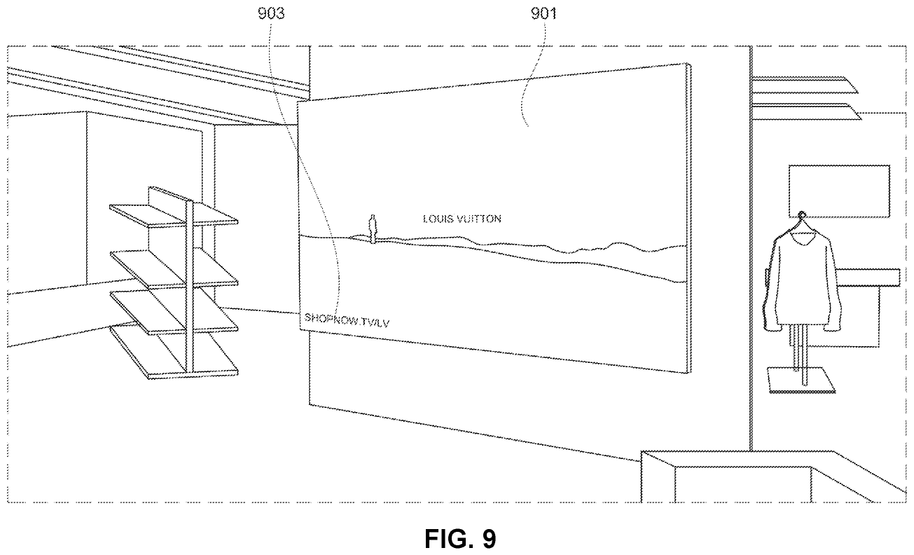

FIG. 9 shows an exemplary broadcast device 901 inside a store. A URI 903 is positioned on the bottom left of the display 901. A consumer can input the URI into an internet web browser. The URI may direct the web browser to a web page from which the interactive video can be played or downloaded on the consumer's device. The interactive video, as discussed, is a copy of the video displayed on the broadcasting device that provides product images and product information of products as those products appear in the video of the broadcast device 901. Consumers can interact with the video to request product information and/or purchase the products displayed on the broadcasting device. The interactive video can play substantially in synch with the video on the broadcast device 901. The consumer can, however, manipulate the temporal progression of the video to access or request information on products displayed in the video.

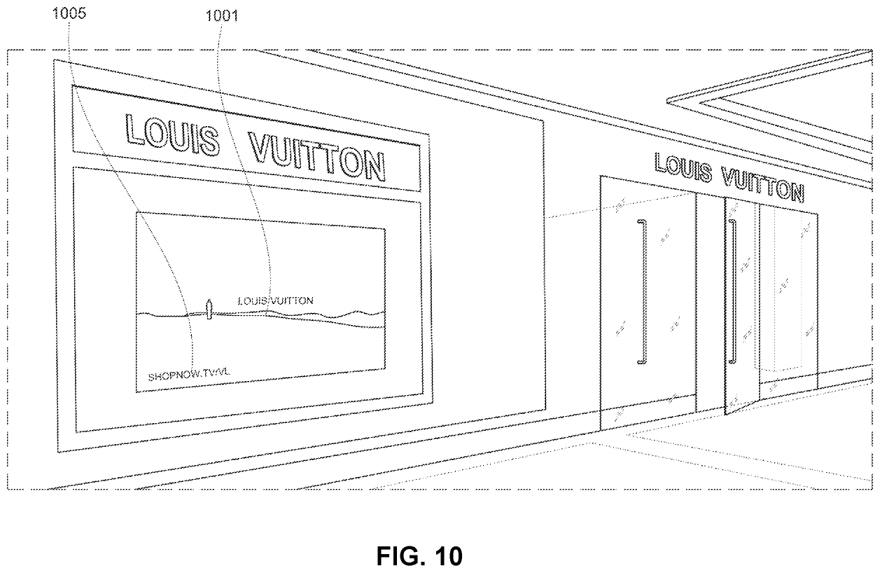

FIG. 10 shows an exemplary broadcast device 1001 in a store window. A URI 1005 is positioned on the bottom left of the video that is displayed on the broadcast device 1001. The URI 1005 is unique to the video that is displayed. However, more than one broadcast device 1001 can display the same video. For example, a plurality of different stores associated with one retailer can all include broadcast devices 1001 that show the same video. Accordingly, the URI 1005 may be unique to the video but not the broadcast device 1005. When the URI 1005 is accessed, e.g., input into a web browser of a consumer's device, an interactive video can be displayed on the consumer's device. The interactive video can be provided to the consumers device via a caching server, e.g., a dedicated network server or service acting as a server that saves web pages or other web content locally.

The invention is not, however, limited to any one mechanism for receiving interactive video content. Nor is the invention limited by how the interactive video content is requested. Some instances for requesting interactive video content can involve matching a specific URI against a video's URI which is created and stored by methods and systems of the invention. The specific URI may match against a physical location's URI, such as, a particular store. For example, a consumer can request interactive video content by inputting a name of a store hosting a broadcasting device with video data. Alternatively, the interactive video content being requested may be identified by systems of the invention based on global positioning device components (commonly found in smartphones) that indicate the consumer device is within a geofence of a defined physical location.

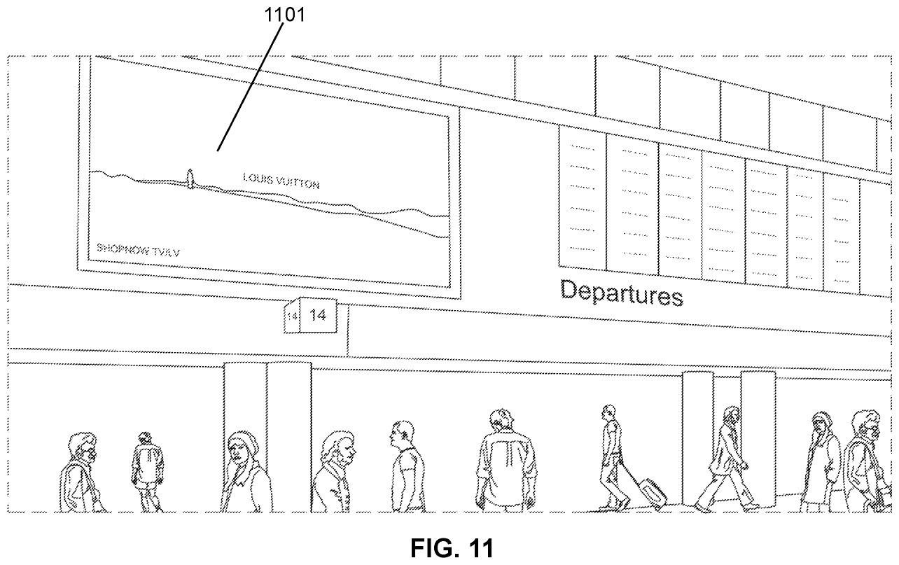

FIG. 11 shows an exemplary broadcast device 1101 at a transport hub. Displayed on the broadcast device 1101 is a video advertisement. The video advertisement includes products for which consumers at the transport hub may or may not have an interest. According to systems and methods described herein, retailers associated with the video advertisement can assess product interest based on consumer requests and interactions with interactive video content. For example, retailers can determine whether a population of people associated with a transport hub are interested in luxury products, such as, expensive handbags. Retailers can compare that interest against consumer interest in less expensive products, such as, cheaper handbags.

Because the broadcast devices display video advertisements separately and concurrently with interactive video content being supplied to consumer devices, retailers can collect data useful for devising business strategies which is not available by any conventional platform. Using systems and methods of the invention, retailers can collect data to assess consumers (e.g., at a transport hub) interest in products or services and make business decisions based on those that data. Retailers can advertise products and collect data from consumers that includes, for example, among a population of consumers, what percentage are interested in a particular product and what percentage are likely to buy the product. This information can be gleaned based on requests for interactive video data, and consumers interactions with the inactive video data, and how long the consumers interact with the interactive video, etc. Depending on the measured interest, a retailer may or may not decide to put a store at or in the vicinity of the transport hub with the products (e.g., expensive handbags) for which an interest was assessed.

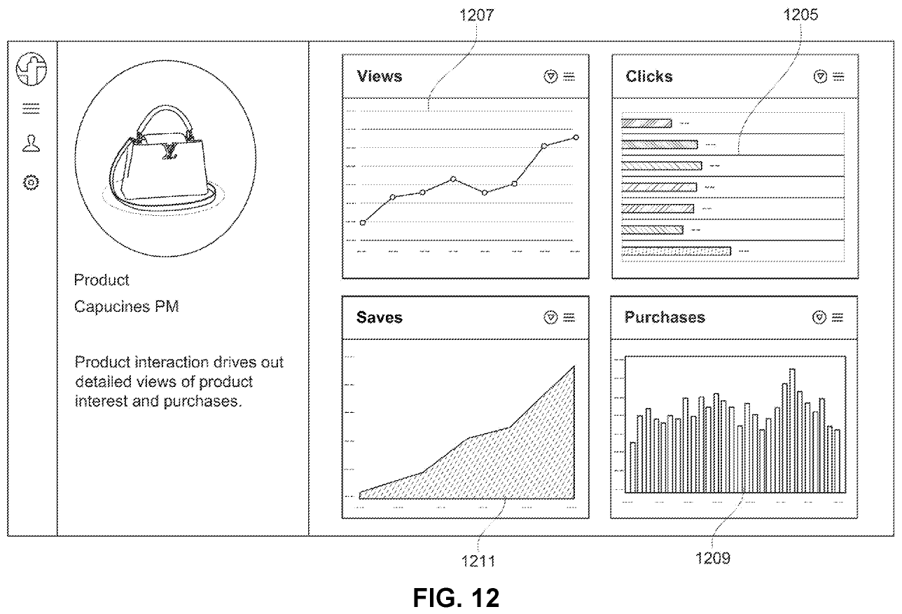

FIG. 12 shows exemplary data collected by systems and methods of the invention. Data may include, among other things, consumer engagement with video content (e.g., clicks 1205). The data may include consumer views 1207, i.e., the number of times the video is opened on a consumer device. The data can provide information relating to the number of consumers that see or pass in the near vicinity of a broadcast device, but do not engage with its content, i.e., do not request interactive video data. The data may include a number of purchases 1209. The data may include a number of times a product is saved 1211 from an interactive video for later viewing. The data may include information relating to how long consumers watch a video or replay a video. Because methods of the invention involve concurrent transmission of video broadcast data and interactive video data (at consumer request) methods of the invention can measure in real time consumer interest in products at any location. Methods can compare consumer interest across different locations. These methods can be used to determine what products to advertise, what information to include in an advertisement, where to advertise, where to open stores, what products to put in those stores, etc.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “non-transitory” is to be understood to remove only propagating transitory signals per se from the claim scope and does not relinquish rights to all standard computer-readable media that are not only propagating transitory signals per se. Stated another way, the meaning of terms such as “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various modifications of the invention and many further embodiments thereof, in addition to those shown and described herein, will become apparent to those skilled in the art from the full contents of this document, including any references to any literature cited herein. All of those modifications and further embodiments are to be considered included herein and part of this disclosure.

1. A method comprising:
providing a computer system comprising at least one processor coupled to non-transitory, computer-readable memory containing instructions executable by the at least one processor to cause the system to communicate and exchange data with a plurality of devices over a network;
receiving a video comprising a plurality of images of products to the computer system;
analyzing the plurality of images to identify the one or more products based, at least in part, on information from a product catalogue database operably associated with the system;
indexing the plurality of images with metadata comprising information related to the products from the product catalogue database;
generating interactive video content from the plurality of indexed images;
receiving, via the network, a request from a consumer device for the interactive video content concurrently with the video being displayed on a broadcasting device; and
communicating the interactive video content to the consumer device.

2. The method of claim 1, wherein the interactive video content comprises video images of the products and, after the communicating step, the video images are displayed on the consumer device concurrent with the video being displayed on the broadcasting device.

3. The method of claim 2, wherein, as products appear from the interactive video content, at least a portion of the metadata related to the products is provided on the consumer device.

4. The method of claim 3, wherein the metadata comprises information relating to price, availability, location, descriptions, or product specifications.

5. The method of claim 1, further comprising receiving, from the consumer device, a purchase request for the product.

6. The method of claim 5, wherein the purchase request is initiated on the consumer device by consumer interaction with the interactive video content.

7. The method of claim 5, further comprising transmitting information related to the purchase request to a third-party device to facilitate a commercial transaction.

8. The method of claim 5, further comprising recording and transmitting, with the computer system, analytical data related to views and/or purchases of the products in the interactive video.

9. The method of claim 1, wherein the product catalogue database comprises information input into the product catalogue database by a retailer.

10. The method of claim 9, wherein the information is automatically, with a computer algorithm, scraped from a web site associated with the retailer.

11. The method of claim 1, wherein the request for the interactive video content is received from the consumer device after the video is displayed on the broadcasting device.

12. The method of claim 1, wherein the broadcasting device is associated with a retailer.

13. The method of claim 1, wherein the request comprises a unique identifier associated with the interactive video content.

14. The method of claim 13, wherein the unique identifier comprises one of a URI matching a URI associated with the video content, a URI matching a URI associated with a location of the broadcasting device, or global positioning coordinates of the consumer device.

15. The method of claim 1, wherein the broadcasting device is located in a public environment.

16. The method of claim 1, wherein the video is transmitted to the broadcasting device.

17. The method of claim 16, wherein the transmitted video comprises a unique identifier.

18. The method of claim 17, wherein consumers request the interactive video content via the unique identifier.

19. A system comprising:
at least one processor coupled to non-transitory, computer-readable memory containing instructions executable by the at least one processor to cause the system to:
receive a video comprising a plurality of images of one or more products;
analyze the plurality of images to identify the one or more products based, at least in part, on information from a product catalogue database;
index the plurality of images with metadata associated with the one or more products;
generate an interactive video;
receive, from a consumer device, a request for the interactive video concurrent with the video being displayed on a broadcasting device; and
provide the interactive video to the consumer device.

20. The system of claim 19, wherein the system is further operable to receive a purchase request from the consumer device and provide information related to the purchase request to a third-party.
